(19) United States
(12) Patent Application Publication
(10) Pub. No.: US 2003/0140343 A1
(43) Pub. Date: Jul. 24, 2003

(54) Remote wireless device with EPG display, intercom and emulated control buttons

(75) Inventors: Barry P. Falvo, Norristown, PA (US); Albert F. Elcock, Havertown, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: General Instrument Corporation

(21) Appl. No.: 10/051,472

(22) Filed: Jan. 18, 2002

(51) Int. Cl. H04N 5/445; H04N 7/18; H04N 7/173

(52) U.S. Cl. 725/51; 725/110; 725/40; 725/111; 725/81

(57) ABSTRACT

A user's remote wireless device is used to send messages to targeted destinations within the user's home environment via an in-home network. The remote wireless device presents a user-friendly menu that enables the user to select the format of the messages (e.g., audio, text and/or graphics). The messages may be set to be sent at a particular time (reminder messages) or sent immediately (intercom messages). An application program running on the remote wireless device emulates on a display of the remote wireless device a plurality of control buttons used to select the destination, format and time, and to control the selection of program channels displayed on a television.

### FIELD OF THE INVENTION

The present invention generally relates to interactive entertainment systems, such as interactive television, and to inter-home communications among multiple cable television (CATV) system service users.

### BACKGROUND INFORMATION

There has been a continuous, serious effort by industry participants to come up with a common set of wireless home network protocols and standards. Such a collaborative effort lead to the consolidation of early numerous primitive proprietary protocols to several major ones, including Wireless Ethernet Compatibility Alliance (WECA) IEEE 802.11b, HomeRF® 2.0 using the standard wireless access protocol (SWAP), and Bluetooth technologies.

Home networking is the collection of elements that process, manage, transport, and store information, enabling the connection and integration of multiple computing, control, monitoring, and communication devices in the home. The need for simple, flexible, and reliable home networks has greatly increased as advancements in telecommunications technology and the development of “smart” devices has continued to progress.

With the advent of digital cable TV, a new era in TV viewing experience has been emerging—one in which video complementary data services are available to the TV viewer. There are many potential methods for experiencing these data services. One such way is to use a second screen such as that of a remote wireless device (e.g., a WebPad). An illustration of such a typical system is shown in FIG. 1.

FIG. 1 shows a conventional two-screen digital cable TV system 100. The system 100 includes a remote wireless device 105. The remote wireless device 105 is connected to a digital set-top box (STB) 110 using a wireless connection. The remote wireless device 105 may also connect directly to a high-speed cable modem, digital subscriber line (DSL) modem or any other equivalent high-speed Internet connection device to access the Internet 135. TV video programming 140 is accessible via STB 110. The wireless connection utilizes an external port 115 on the STB 110, such as a Universal serial bus (USB), Ethernet, or IEEE 1394 port equipped with an access point 120 that communicates with the remote wireless device 105 over a wireless radio frequency (RF) link 125. The access point 120 in this scenario is a device designed for a specific interface (e.g., USB) and is used to support wireless connectivity. Typical wireless connection protocols that may be used by TV system 100 include, but are not limited to, HomeRF and IEEE 802.11. A more traditional wired connection simply includes a cable or wire between the STB 110 and the remote wireless device 105, again using a USB, Ethernet, or IEEE 1394 port. The STB 110 is also connected to a television 130.

The two-screen digital cable TV system 100 allows for many enhanced capabilities over a one-screen system. For example, a user can view Internet data on the screen of the remote wireless device 105, while watching video uninterrupted on the television 130. In another example, STB applications that are normally viewed on the television screen are viewed on the screen of the remote wireless device 105, leaving the television available for video program viewing.

Traditional wireless home-networking technology is used for line-of-sight, infrared, unidirectional, hand-held controller applications. Wireless-based transport element technology is used to distribute multiple types of information within the home. Wireless RF transmission is the recognized home-networking topology of choice for the emerging network-centric home as a result of its flexibility, mobility, and ability to network without wired connections. Consumers will require a system that manages everything within the home, including voice, data, and appliances. Wireless technology will provide necessary convenience, simplicity, and long-term cost savings. A two-screen digital cable TV system using a remote wireless device can be modified to support and advance the features provided by wireless home-networking technology.

### SUMMARY OF THE INVENTION

In accordance with the present invention, a CATV system including a local device in communication with a remote server and a television, uses a remote wireless device to send at least one of a text message and an audible message to at least one desired destination, and controls the selection of program channels displayed on the television. The wireless device has a display. An application running on the wireless device is executed. A user generates the message using the wireless device. One or more control buttons emulated by the application on the display is used to select the desired destination and to control the selection of the program channels.

In accordance with one embodiment of the present invention, a remote wireless device is used to send a message to at least one desired destination via a communications system. The remote wireless device has a display. An application running on the wireless device is executed. The application presents on the display a plurality of selectable message destinations and a plurality of selectable message formats. A user generates a message using the wireless device. One or more control buttons emulated by the application on the display are used to select (i) at least one of the destinations to which the generated message is to be sent, and (ii) at least one of the formats which define how the generated message is to be presented at the selected destinations.

The communications system may be a cable television system which includes a local device in communication with a remote server and a television. The local device may communicate electronic program guide (EPG) data to the wireless device. The application may use at least a portion of the EPG data to provide an EPG menu on the display. The control buttons may be used to navigate the EPG menu and make program channel selections displayed on the television without displaying the EPG menu on the television.

The remote server may communicate the EPG data to the local device. In response to the user selecting a particular program channel while navigating the EPG menu, the wireless device may send one or more instructions to cause the particular program channel to be displayed on the television. The one or more instructions may be included in a signal wirelessly transmitted from an output port of the wireless device to the local device or television over at least one of a radio frequency (RF) link and an infrared (IR) link.

Updated EPG data may be communicated from the remote server to the wireless device via the local device on a periodic basis to refresh the application. The wireless device may automatically transmit, on a periodic basis, a signal to the local device requesting that updated EPG data be communicated from the remote server to the wireless device via the local device to refresh the application. The signal may use a file transfer protocol.

The selectable message destinations may include at least one of the local device, the television, a computer, the wireless device and another wireless device. The wireless devices may be connected to a wireless local area network (WLAN). The local device may be an STB or a modem.

At least one of a text message and an audible message generated by a user of the local device or the remote wireless device may be received at the remote wireless device. The remote wireless device may be used to control the selection of program channels displayed on the television. The user may record an audible message at the wireless device. The user may enter a text message at the wireless device.

The application may present on the display a plurality of selectable predetermined messages. The control buttons may be used to select at least one of the predetermined messages to be sent to the selected destinations. The user may enter information into the remote wireless device to schedule when the generated message is to be sent. One of the control buttons may be used to immediately send the generated message to the selected destinations. The selectable message formats may include a text format, an audible format and a graphics format.

In yet another embodiment of the present invention, a remote wireless device includes a display, an input device used to generate a message, and an application running on the wireless device. The application presents on the display a plurality of selectable message destinations and a plurality of selectable message formats. The application emulates on the display a plurality of control buttons used to select (i) at least one of the destinations to which the generated message is to be sent, and (ii) at least one of the formats which define how the generated message is to be presented at the selected destinations.

The wireless device may be used to control the selection of program channels displayed on a television that is in communication with a local device. The application may use at least a portion of electronic program guide (EPG) data received from the local device to provide an EPG menu on the display of the remote wireless device. The control buttons may be used to navigate the EPG menu and make program channel selections displayed on the television without displaying the EPG menu on the television.

The input device may generate text messages and store audible messages. The remote wireless device may include a speaker and a receiver that receives at least one of a text message and an audible message generated by a user of a local device or the remote wireless device. Received text messages may be presented on the display of the remote wireless device and received audible messages may be outputted from the speaker.

The application may present on the display a plurality of selectable predetermined messages. The control buttons may be used to select at least one of the predetermined messages to be sent to the selected destinations. The remote wireless device may include a timer used to schedule when the generated message is to be sent.

In yet another embodiment of the present invention, a local device in communication with a remote server and a television includes an input device that generates text messages, a recorder that stores audible messages, and a plurality of control buttons used to select at least one destination to send at least one of the text and audible messages to.

The control buttons may be used to select, from a menu presented on the television by the local device, a predetermined message to send to the destination, and to control the selection of program channels displayed on the television. The local device may be an STB or a modem. The destination may be at least one of the television and a remote wireless device.

The local device may include a receiver that receives at least one of a text message and an audible message generated by a user of the local device or the remote wireless device. The received text messages may be presented on a display on the television and received audible messages may be outputted from a speaker in the television. The local device may include a timer used to schedule when the messages are to be sent.

In yet another embodiment of the present invention, a remote wireless device is used to send a message to at least one desired destination via a communications system. The wireless device has a display. A message is inputted into the remote wireless device. At least one destination is selected to where the message is to be sent from a plurality of destinations presented on the display. At least one format in which the message is to be presented is selected from a plurality of formats presented on the display. A time is set when the message is to be sent to the selected destination. A software timer is initiated in the wireless device. When the software timer expires, the message is sent to the selected destination. The message is presented in the selected format at a device associated with the selected destination.

The communications system may be a cable television system which includes a local device in communication with a remote server and a television. The plurality of destinations may include at least one of the local device, the television, a computer, the wireless device and another wireless device. The wireless devices may be used to control the selection of program channels displayed on the television. The local device may be an STB or a modem.

The message may be encapsulated as a wireless message. The device associated with the selected destination may decode the encapsulated message. The message may be a reminder message. The format may be at least one of text and audio. The format may be a graphics format. The message may be inputted into the remote wireless device by selecting a previously created message from a plurality of messages presented on the display.

In yet another embodiment of the present invention, a remote wireless device is used to send a message to at least one desired destination via a communications system. The wireless device has a display. A message is inputted into the remote wireless device. At least one destination is selected to where the message is to be sent from a plurality of destinations presented on the display. At least one format in which the message is to be presented is selected from a plurality of formats presented on the display. The message is sent to the selected destination. The message is presented in the selected format at a device associated with the selected destination.

### BRIEF DESCRIPTION OF THE DRAWINGS

The following detailed description of preferred embodiments of the present invention would be better understood when read in conjunction with the appended drawings. For the purpose of illustrating the present invention, there are shown in the drawings embodiments which are presently preferred. However, the present invention is not limited to the precise arrangements and instrumentalities shown. In the drawings:

FIG. 1 shows a conventional two-screen digital cable TV system;

FIG. 2 shows a two-screen digital cable TV system having both RF and IR links to a set-top box in accordance with the present invention;

FIG. 3 shows a digital cable TV system including an in-home network in accordance with the present invention;

FIG. 4 shows several interconnecting components of a reminder and intercom system in accordance with the present invention;

FIG. 5 illustrates a process of packetizing intercom messages for delivery over an RF network;

FIG. 6 shows a top plan view of a wireless display device operating in accordance with the present invention;

FIGS. 7-11 show how menu options of a display device are selected to create, delete and change messages, and select message formats in accordance with the present invention; and

FIG. 12 is a flow chart that illustrates a method implemented in accordance with the present invention.

### DETAILED DESCRIPTION OF THE INVENTION

In accordance with a first embodiment of the present invention, STB native applications that are normally viewed on a television connected to the STB are viewed on a remote wireless device, leaving the television available for video program viewing. Interaction with an STB native application is accomplished through a remote application executing on the remote wireless device. This is primarily beneficial because it allows a viewer the luxury of doing all STB interactions through one device.

An electronic program guide (EPG) application is interacted with through a remote application executing on a processor in a remote wireless device. An EPG is typically displayed on a television connected to an STB and is manipulated with commands received from a wireless remote control. To satisfy the desire to manipulate an STB native EPG application without interfering with TV video programming being shown on the television, a remote application that resembles the STB native EPG application is run on a processor within the wireless remote control, causing the EPG to be displayed on a screen of the wireless remote control. This remote application in a sense is very similar to the STB native EPG application in that it needs to have access to program data and be able to render it for display to the viewer.

The remote EPG application needs to mimic the STB EPG application in two primary ways. First, the EPG application needs to display program information. Second, the EPG application needs to command the STB to change channels. The EPG application of the remote wireless device physically receives program information data over a wireless connection, i.e., through an access point. The access point, in turn, receives the program information data either from the data stored in the STB (e.g., the same data that gets used by the STB native EPG), or directly from an Internet server through the high-speed cable modem in the STB.

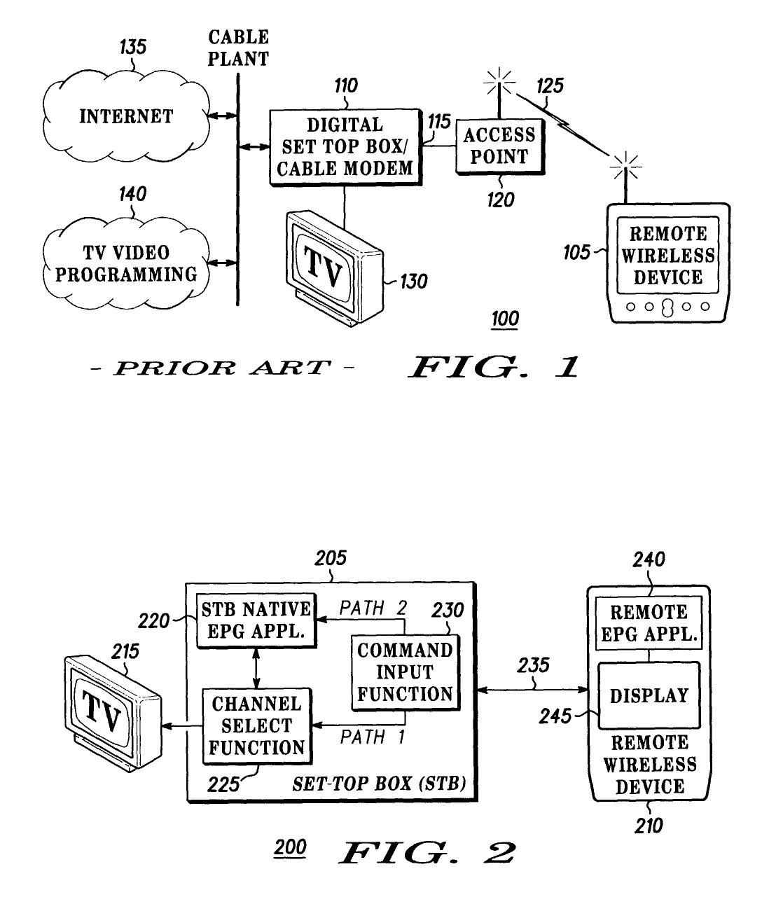

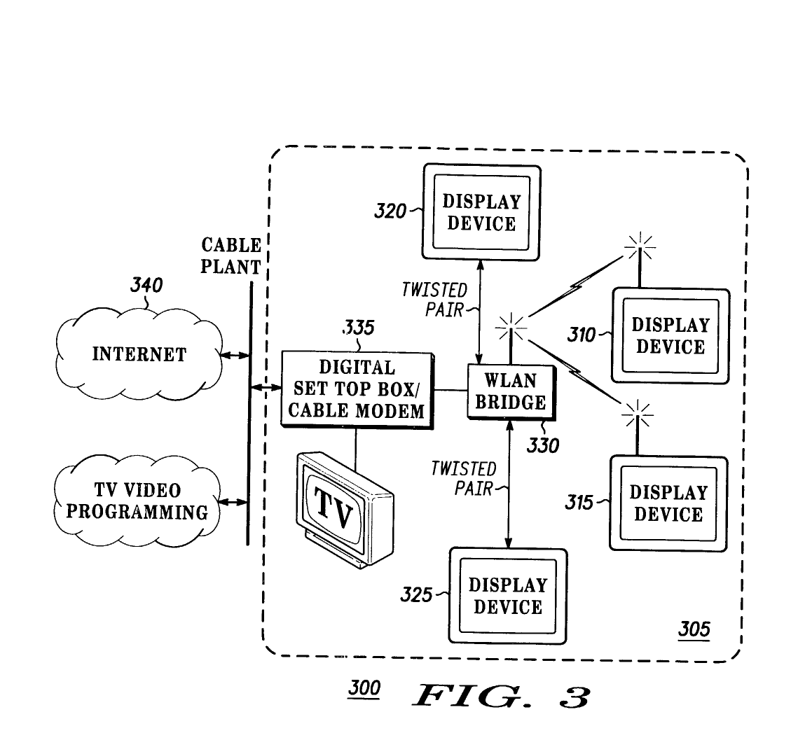

FIG. 2 shows a two-screen digital cable TV system 200 using two command scenarios in accordance with the present invention. The two-screen digital cable TV system 200 includes an STB 205 in communication with a television 215, and a remote wireless device 210 including a display 245. The television 215 serves as a “first screen device” and the remote wireless device 210 serves as a “second screen device.” Typically, an STB native EPG application 220 within STB 205 commands the STB 205 to change channels by communicating with a channel select function 225 within the STB 205 that controls channel change. Communication between the a remote EPG program running on a processor within remote wireless device 210, and a command input function 230 in the STB 205, occurs through a wireless (radio frequency (RF) or an infrared (IR)) link 235. Commands are received by a command input function 230 within STB 205 via the wireless link 235 from the remote EPG application 240. The command input function 230 either directly controls the channel select function 225 (via path 1) based on commands received from the remote wireless device 210, or forwards the received commands to the STB native EPG application 220 (via path 2) as an intermediary interface to control the channel select function 225. The wireless link 235 may include an access point that is connected directly to STB 205 (see access point 120 in FIG. 1). STB 205 may include an internal cable modem, or may connect to an access point in the wireless link 235 via an external cable modem.

In another embodiment of the present invention, and still referring to FIG. 2, the remote wireless device 210 that is used as a navigation device for the STB native EPG application 220 in STB 205 is emulated on the display 245 on the remote wireless device 210. Commonly, an STB is controlled with a remote wireless device without a display. By incorporating display 245 into the remote wireless device 210, the controls used to communicate with the STB 205 is emulated on the display 245 of the remote wireless device 210, alone or in conjunction with physical buttons residing on the surface of the remote wireless device 210. This emulation can either be accomplished by executing a software emulation of the physical characteristics of a remote control on display 245 of the remote wireless device 210, or by using the physical buttons that reside on the surface of the remote wireless device 210. Either method accomplishes the same result. For example, the remote wireless device 210 may have a plurality of physical buttons to control a channel up/down function. The user depresses these buttons in the same manner as a conventional remote wireless device without a display. Alternatively, “soft” buttons in an application executing on the display 245 of the remote wireless device 210 may be selected by the user (e.g., through the use of a stylus or a touch screen) to accomplish the same result. Thus, the viewer ultimately has a choice of four options for controlling the channel up/down function as follows:

1. Depress physical buttons that exist on the face of the STB 205;

2. Depress physical buttons on a conventional remote wireless device;

3. Depress physical buttons on the remote wireless device 210; and

4. Select emulated “soft” buttons on an application executed on the display 245 of remote wireless device 210.

By controlling the channel up/down function through one of options 2, 3, and 4, the remote wireless device 210 generates a corresponding command that is interpreted by the STB native EPG application 220 and/or the channel select function 225 when the command is communicated to STB 205 via the wireless link 235.

When control buttons are emulated in an application running on the remote wireless device 210, several different graphical techniques could be implemented. A graphical representation of a particular type of conventional remote wireless device may be created without a display, or a variation, generic representation, or the like, on the display 245 of the remote wireless device 210. Other graphical abstractions that ultimately result in equivalent functionality emulated on the display 245 of the remote wireless device 210 may be created.

In another embodiment of the present invention, the remote wireless device is used in conjunction with an in-home network to enhance communication with other occupants in the same home. This embodiment implements a “reminder message” feature and an “intercom message” feature.

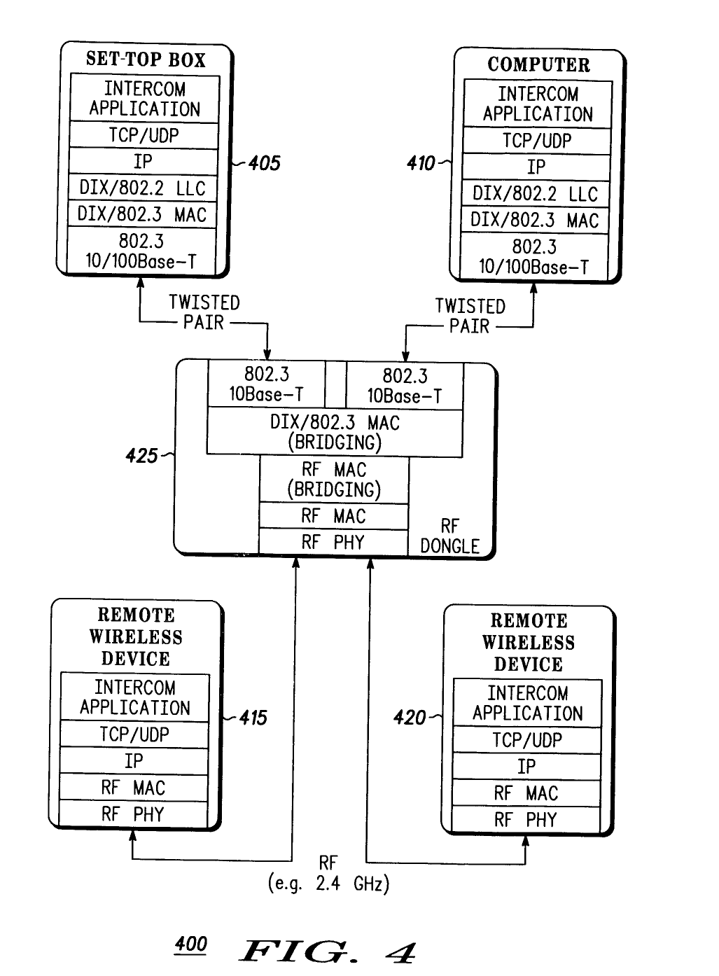

FIG. 3 shows a digital cable TV system 300 including an in-home network including wireless display (remote wireless) devices 310, 315 and wired display devices 320, 325 used to create reminder and intercom messages using a wireless local area network (WLAN) 330 that is bridged either to a cable modem within an STB 335 or a stand-alone cable modem (not shown) to allow access to the Internet 340. Data received from the Internet 340 is primarily routed from the cable modem in STB 335 to the display devices 310, 315, 320, 325 through the WLAN Bridge 330. The display devices 310, 315, 320, 325 support both HomeRF and 802.11b wireless protocols.

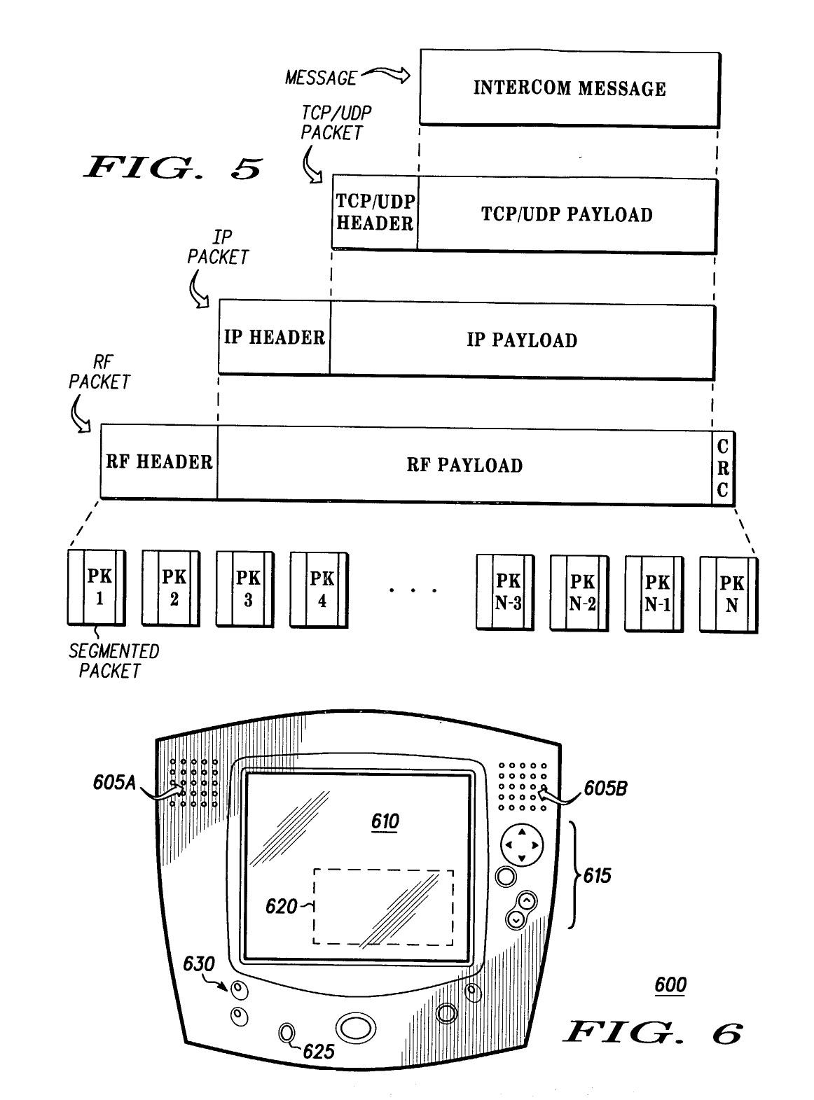

FIG. 4 shows further details of an in-home network 400 used to implement the reminder and intercom features of the present invention. In the in-home network 400, a WLAN Bridge 425 is utilized as a hub/router/switch to connect wired display devices 405, 410 and wireless display (remote wireless) devices 415, 420 and form a local area network (LAN). The connection between display device 405 (e.g., an STB), and other wired devices, such as display device 410 (e.g., a computer) to the WLAN Bridge 425 is made via a wired twisted pair Ethernet connection. The connection between the wireless display device 415 and wireless display device 420, to the WLAN Bridge 425 is made via a wireless (RF) network connection (e.g., 802.11, HomeRF, or the like).

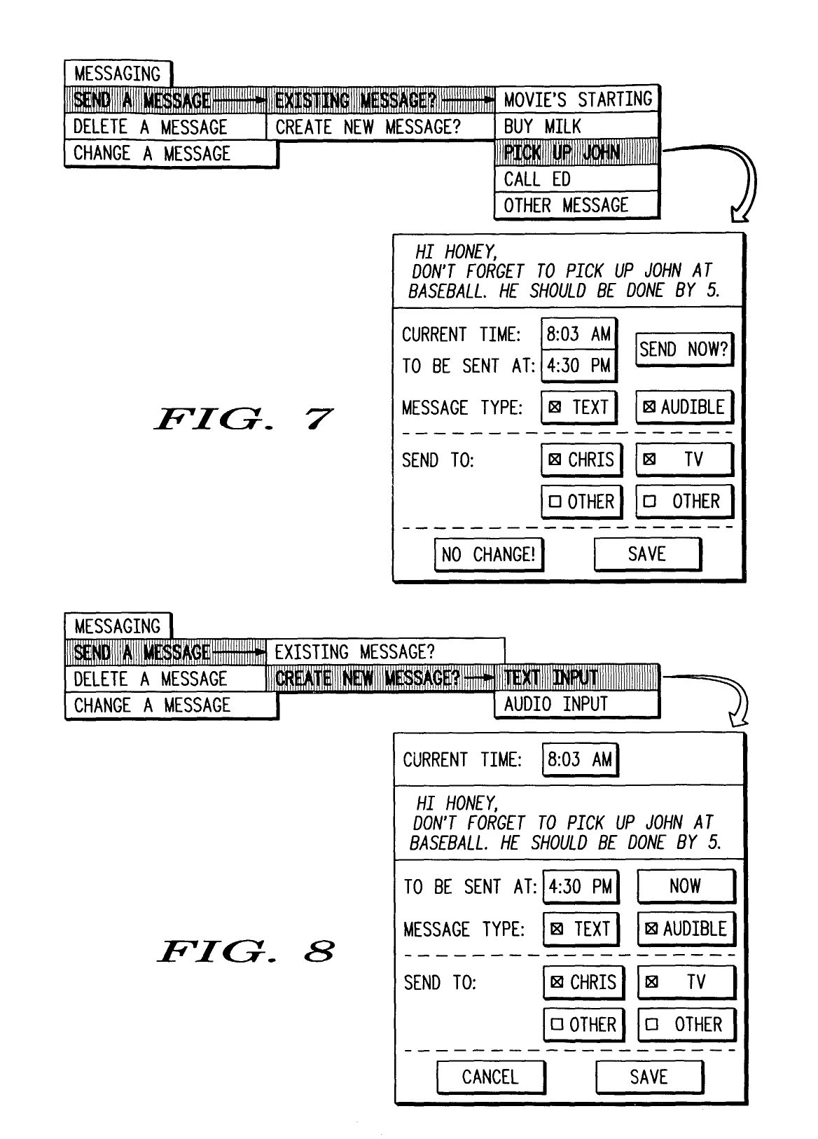

Any device within the LAN shown in FIG. 4 that wishes to send a message to another device on the LAN packetizes the message as shown in FIG. 5, utilizing a transmission control protocol (TCP), a user datagram protocol (UDP), or an equivalent communications protocol, and transmits the packet onto the LAN. The WLAN Bridge 425 routes the packet based on the destination specified. If the packet is a broadcast packet, then the packet transmits to all devices on the LAN.

Referring again to FIG. 4, if the wireless display device 415 is sending a message to wireless display device 420, the wireless display device 415 packetizes the message, addresses it to wireless display device 420 and transmits the packet to the WLAN Bridge 425. The WLAN Bridge 425 receives the packet, inspects the destination address of the packet and routes the packet to wireless display device 420 via the wireless (RF) connection. In this scenario, the wired display devices 405, 410 never “see” the packet.

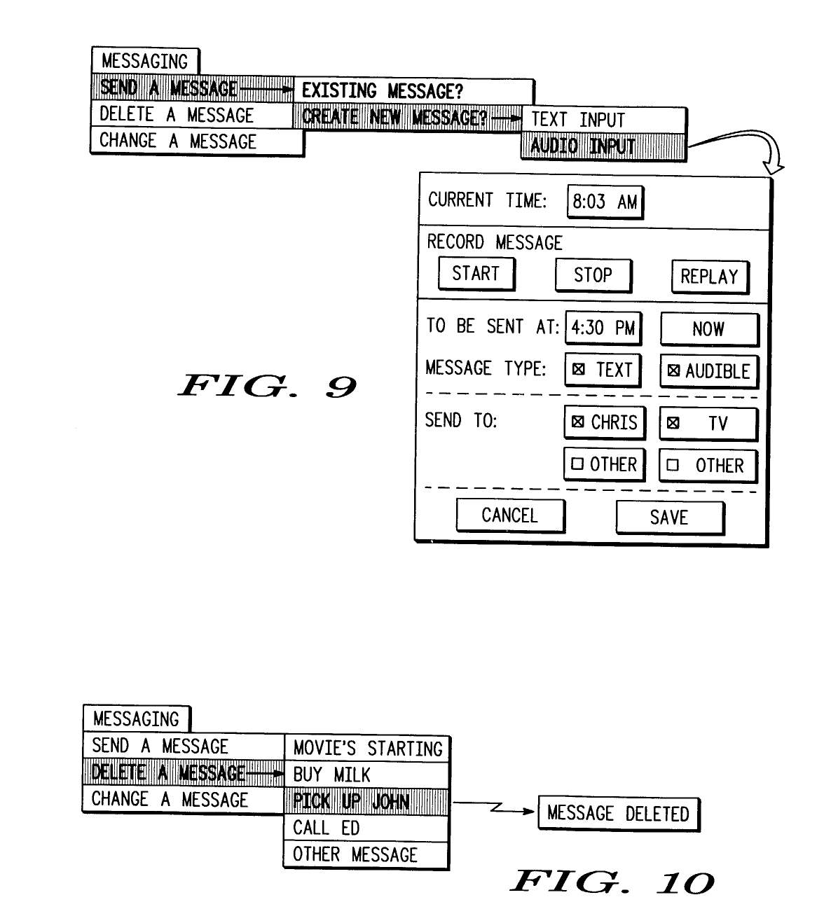

As shown in FIG. 6, a display (remote wireless) device 600 is equipped with stereo speakers 605A, 605B, for outputting audible messages and a touchscreen display 610 for presenting text reminder and intercom messages. Messages including graphics (images) may also be generated and presented using display device 600. The display device 600 also includes navigation controls 615 (i.e., up, down, left, right and select), a microphone 625 for recording audible reminder and intercom messages, a keyboard 620 emulated on the touchscreen display 610 for creating/inputting text reminder and intercom messages, and LEDs 630 for providing user feedback. The display device 600 may also include a physical keyboard (not shown).

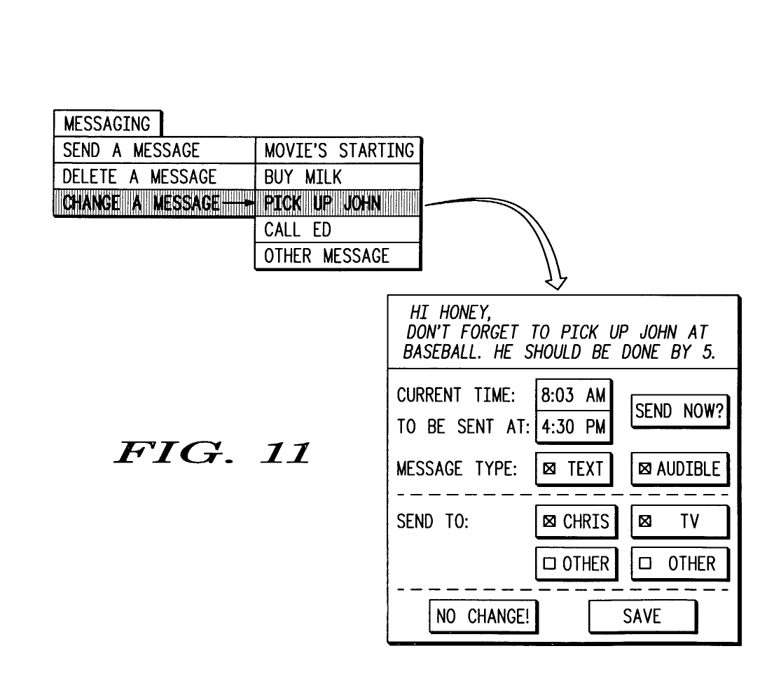

FIGS. 7-9 show the reminder message feature that enables a message originator to program a destination and time at which a reminder message, created/inputted or selected by the message originator, is to be sent. The destination is normally located in the same home as the message originator. The intercom message feature is almost identical to the reminder feature except that an intercom message created/inputted or selected by the message originator is sent without delay. Reminder and intercom text messages may be created using an emulated keyboard, navigation controls, or a physical keyboard residing on the display devices described above. Reminder and intercom audio messages may be created using a recording device and a microphone residing on the display device. When a message originator desires to send a reminder or intercom message, the message originator is given the choice to either select an existing message (see FIG. 7) or create a new one (see FIG. 8 for the creation of a text message and FIG. 9 for the creation of an audio message). A user-friendly interface presents a menu of options that enable a message originator to carry out the following functions:

1. Type or write a text message;

2. Record an audio message using start record, stop record and replay functions (see FIG. 9);

3. Select the time that the message is to be sent or send the message immediately (“Send Now”);

4. Select the format of the message to be sent (e.g., audio and/or text); and

5. Select the destination device(s).

FIG. 10 shows an interface for deleting a previously created and stored message. The selection to delete a message presents the user with a list of the current messages available to be selected on the display device. Selecting one of the messages initiates the deletion process.

FIG. 11 shows an interface for changing a previously created and stored message, and/or its transmission parameters (destination, format, or the like). After the changes are made, the user can elect to save the changes, or not make the changes by pressing a “no change” function.

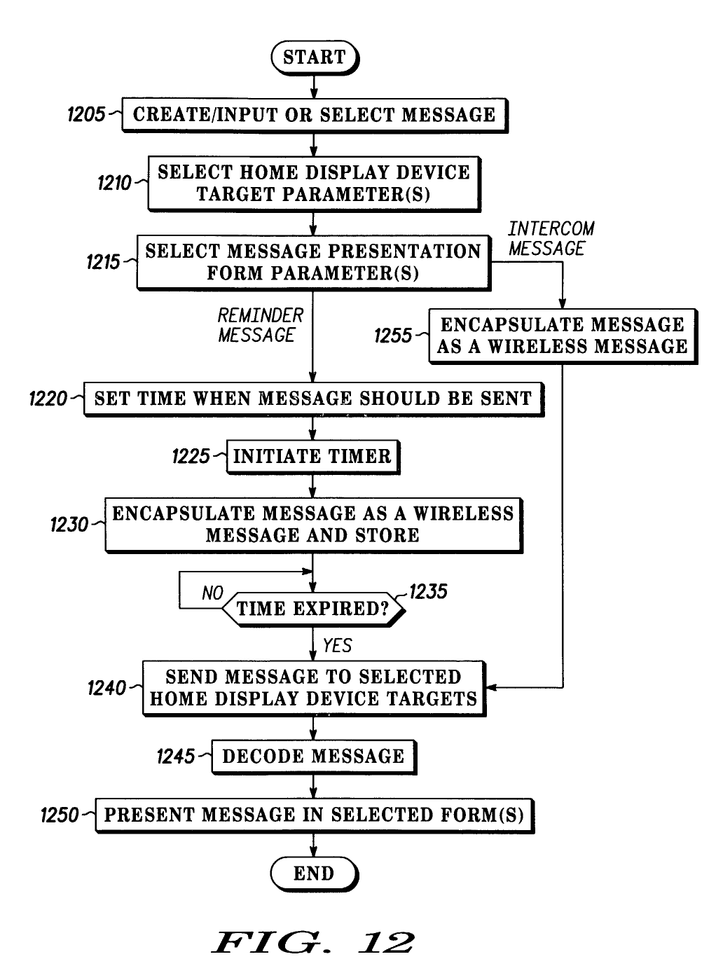

FIG. 12 shows a method of implementing a reminder messaging feature. The process starts with the message originator creating/inputting a new reminder message or selecting a previously created (existing) reminder message (e.g. “David at soccer practice. Pick up at 5:00 P.M. at Westgate field.”) using a display device connected to the in-home network (step 1205). The message originator also sets up a plurality of message transmission parameters. The message originator selects a home display device target parameter(s) indicating a destination(s) (e.g., an STB/TV, a first remote wireless display device, a second remote wireless display device, the display device used to create or select the reminder message, all of the display devices, or the like) located within the same home as the message originator to which the reminder message is to be sent (step 1210). The message originator also selects a parameter(s) indicating the format(s) in which the message should be presented (e.g., audible, visual or both) (step 1215) and sets a time for the reminder message to be sent (step 1220). After the message originator saves the reminder message and message transmission parameters, a software timer is initiated (step 1225) and the reminder message is encapsulated as a wireless (e.g. 802.11b or HomeRF) message and stored in a memory within the display device used to initiate the reminder feature (step 1230). When the software timer expires (step 1235), the reminder message is sent to all home display device targets as previously selected by the message originator (step 1240). The devices that receive the reminder message, decode the reminder message (step 1245) and present/output it in the format(s) selected by the message originator (step 1250).

Referring again to FIG. 12, when implementing the intercom messaging feature, method steps 1220, 1225, 1230 and 1235 used to implement the reminder messaging feature are replaced with a single step that encapsulates an intercom message as a wireless (e.g. 802.11b or HomeRF) message (step 1255) without having to store the intercom message or the transmission parameters. The message originator creates/inputs the new intercom message or selects a previously created (existing) intercom message using the same display device used to send reminder messages (e.g. “Bobby is here! ” or “It's dinner time! ”). However, upon the completion of the intercom messaging feature programming by the message originator, the message originator activates a “send now” function on the display device to immediately send the intercom message to all display device targets selected by the message originator.

The reminder and intercom messaging features may use emulated buttons/controls to send, delete, and change messages and their formats, as well as to set the software timer. The software used to implement the reminder and intercom message features is designed to preclude very few applications from “hooking” into its feature set. For example, an Intercom application might have an Application Program Interface (API) called: set_reminder with message_name, date and time as inputs.

The present invention is fully implemented in a software application. The different components of the application may include a user interface, an input message translator and a communications interface.

The communications layer (COMML) is tailored to the target hardware. For example, in a wireless display device, the COMML uses IP and a wireless protocol. If the target destination is an STB, it uses IP only.

The User Interface Layer is responsible for rendering the application to the user and accepting user input (key presses, a new message, etc.). This is implemented with off-the-shelf window building tools and just requires a graphic artist to compose the screens.

The Message Translation Layer (MTL) interprets the input from the user (e.g., a button press) and translates it in its context. For example, if the button pressed was the selection of a frequently used target device (“Chris”), the MTL translates it to the corresponding IP address for the device named “Chris”.

The COMML Layer takes the input from the MTL and packetizes it according to the message protocol. After this is done, the COMML sets the timer in the microprocessor to expire at the appointed time.

The reminder and intercom messaging application uses predefined interfaces. These predefined interfaces are each driven by their own software components, called drivers. The reminder and intercom messaging application use the API for those drivers to get the hardware to perform the desired functions.

Canned (previously stored) messages are coded as defaults that appear with an arbitrary name to the user. For example, the message “Pick up John at 5:30 PM. Lynnewood field” might be named “Pick up John”. The user creates a new message much like someone who types (or writes using a touch screen) a message on a PC. The Message Translation Layer forwards the message along with other selected input (i.e., time to send the message, target device, etc.) to the COMML to create the message and set the timer. All storage of messages may take place in a Flash memory. This is also much the same as a PC hard disk. From the user perspective, an icon is pressed (i.e., the picture of a disk or a save button) and from the system perspective a function called “file_write” is invoked to save to the hard disk.

The software timer function writes a value to a register (based on processor speed) that is used by the microprocessor to determine how much time is left. It also tells the microprocessor which function (called an Interrupt Routine) to run when the timer expires. It is then up to the microprocessor to monitor the timer. When there is no time left, the microprocessor initiates the Interrupt Routine that in turn activate the reminder and intercom application to let it know that it is time to send a message and the application sends the prepackaged message.

The process used for generating audible messages is much the same as the process used for the text messages. The software support for generating an audio output file is already implemented and is distinct from the application. The application sends the file generated by the audio program to the intended target.

The wireless display device has a wireless transceiver. With respect to the reminder and intercom messaging application, the wireless display devices, STB and computer support the TCP/IP protocol.

Furthermore, the wireless protocol is a standard protocol that the intercom application does not care about except to know the message structure. The wireless protocol conforms to a standard regardless of the application that uses it. The reminder and intercom messaging application puts the message in an envelope that the wireless device can use to send, known as a function call.

The STB does not have built-in speakers, but rather uses the speakers of a TV or externally connected speakers. Computers, of course, generally have an internal speaker and external speakers can be easily added. As discussed above, support for a microphone input, or more importantly, the ability to create an audio file, is the responsibility of the display device itself, and not of the reminder and intercom messaging application.

For the intercom messaging application, all messages are displayed (or played in the case of an audio message) immediately upon receipt. Audio messages are simply missed if the user is not present when they are received. Received text messages are displayed until the user dismisses them by pressing the OK button. If a received text message is presented on a display device, the user either uses the touch screen or an ENTER button on the keyboard. If the message is viewed on a TV via an STB, pressing the OK button on the display device causes the message to be dismissed.

There is no provision made for a received message to be saved or forwarded. Both the display devices and the STB support saving user input, but since the reminder and intercom messaging application is not intended to be used like an e-mail or Instant Messaging (IM), there is no need to provide the ability to store or forward.

All messages are received and interpreted using the standard TCP/IP protocol. In an alternate embodiment, a message may be saved on the STB and receipt of an audio message may be acknowledged prior to being automatically dismissed.

Destinations used to target messages (e.g., “Chris,” “TV,” “Other”) are programmed by associating and storing an IP address with each target via a setup screen on the display device. Once set up, the information is stored in Flash memory and retrieved when needed. When any message is sent to a target (i.e., “Chris”), the software checks the Flash memory for “Chris” which, for example, is “co-stored” with IP address 123.23.34.121. The IP address is extracted and used to send the message to the correct target via the TCP/IP protocol.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A method of using a remote wireless device to send a message to at least one desired destination via a communications system, the wireless device having a display, the method comprising:
(a) executing an application running on the wireless device, the application presenting on the display a plurality of selectable message destinations and a plurality of selectable message formats;
(b) a user generating a message using the wireless device; and
(c) using one or more control buttons emulated by the application on the display to select (i) at least one of the destinations to which the generated message is to be sent, and (ii) at least one of the formats which define how the generated message is to be presented at the selected destinations.

2. The method of claim 1, wherein the communications system is a cable television system which includes a local device in communication with a remote server and a television, the method further comprising:
(d) the local device communicating electronic program guide (EPG) data to the wireless device, the application using at least a portion of the EPG data to provide an EPG menu on the display; and
(e) using the control buttons to navigate the EPG menu and make program channel selections displayed on the television without displaying the EPG menu on the television.

3. The method of claim 2, further comprising:
(f) the remote server communicating the EPG data to the local device; and
(g) in response to the user selecting a particular program channel while navigating the EPG menu, the wireless device sending one or more instructions to cause the particular program channel to be displayed on the television.

4. The method of claim 3, wherein the wireless device automatically transmits, on a periodic basis, a signal to the local device requesting that updated EPG data be communicated from the remote server to the wireless device via the local device to refresh the application.

5. The method of claim 3, wherein the one or more instructions are included in a signal wirelessly transmitted from an output port of the wireless device to the local device over at least one of a radio frequency (RF) link and an infrared (IR) link.

6. The method of claim 3, wherein the one or more instructions are included in a signal wirelessly transmitted from an output port of the wireless device to the television over at least one of a radio frequency (RF) link and an infrared (IR) link.

7. The method of claim 3, wherein updated EPG data is communicated from the remote server to the wireless device via the local device on a periodic basis to refresh the application.

8. The method of claim 2, wherein the selectable message destinations include at least one of the local device, the television, a computer, the wireless device and another wireless device.

9. The method of claim 8, wherein the wireless devices are connected to a wireless local area network (WLAN).

10. The method of claim 2, wherein the local device is one of a set-top box (STB) and a modem.

11. The method of claim 2, further comprising:
(f) receiving, at the remote wireless device, at least one of a text message and an audible message generated by a user of the local device or the remote wireless device.

12. The method of claim 2, wherein the remote wireless device is used to control the selection of program channels displayed on the television.

13. The method of claim 1, wherein step (b) further comprises:
(b)(i) the user recording an audible message at the wireless device.

14. The method of claim 1, wherein step (b) further comprises:
(b)(i) the user entering a text message at the wireless device.

15. The method of claim 1, further comprising:
(d) the application presenting on the display a plurality of selectable predetermined messages; and
(e) using the control buttons to select at least one of the predetermined messages to be sent to the selected destinations.

16. The method of claim 1, further comprising:
(d) the user entering information into the remote wireless device to schedule when the generated message is to be sent.

17. The method of claim 1, further comprising:
(d) using one of the control buttons to immediately send the generated message to the selected destinations.

18. The method of claim 1, wherein the selectable message formats include a text format and an audible format.

19. The method of claim 1, wherein the selectable message formats include a graphics format.

20. A remote wireless device, comprising:
(a) a display;
(b) an input device used to generate a message; and
(c) an application running on the wireless device, wherein the application presents on the display a plurality of selectable message destinations and a plurality of selectable message formats, and emulates on the display a plurality of control buttons used to select (i) at least one of the destinations to which the generated message is to be sent, and (ii) at least one of the formats which define how the generated message is to be presented at the selected destinations.

21. The remote wireless device of claim 20, wherein the wireless device is used to control the selection of program channels displayed on a television that is in communication with a local device.

22. The remote wireless device of claim 21, wherein the selectable message destinations include at least one of the local device, the television, a computer, the wireless device and another wireless device.

23. The remote wireless device of claim 22, wherein the wireless devices are connected to a wireless local area network (WLAN).

24. The remote wireless device of claim 21, wherein the application uses at least a portion of electronic program guide (EPG) data received from the local device to provide an EPG menu on the display of the remote wireless device, and the control buttons are used to navigate the EPG menu and make program channel selections displayed on the television without displaying the EPG menu on the television.

25. The remote wireless device of claim 21, wherein the local device is one of a set-top box (STB) and a modem.

26. The remote wireless device of claim 20, wherein the input device generates text messages and stores audible messages.

27. The remote wireless device of claim 26, further comprising:
(d) at least one speaker; and
(e) a receiver that receives at least one of a text message and an audible message generated by a user of a local device or the remote wireless device, wherein received text messages are presented on the display of the remote wireless device and received audible messages are outputted from the speaker.

28. The remote wireless device of claim 20, wherein the application presents on the display a plurality of selectable predetermined messages, and the control buttons are used to select at least one of the predetermined messages to be sent to the selected destinations.

29. The remote wireless device of claim 20, further comprising:
(d) a timer used to schedule when the generated message is to be sent.

30. A local device, the local device being in communication with a remote server and a television, the local device comprising:
(a) an input device that generates text messages;
(b) a recorder that stores audible messages; and
(c) a plurality of control buttons used to select at least one destination to send at least one of the text and audible messages to.

31. The local device of claim 30, wherein the control buttons are used to select, from a menu presented on the television by the local device, a predetermined message to send to the destination, and to control the selection of program channels displayed on the television.

32. The local device of claim 30, wherein the local device is one of a set-top box (STB) and a modem.

33. The local device of claim 30, wherein the destination is at least one of the television and a remote wireless device.

34. The local device of claim 30, further comprising:
(d) a receiver that receives at least one of a text message and an audible message generated by a user of the local device or the remote wireless device, wherein received text messages are presented on a display on the television and received audible messages are outputted from a speaker in the television.

35. The local device of claim 30, further comprising:
(d) a timer used to schedule when the messages are to be sent.

36. A method of using a remote wireless device to send a message to at least one desired destination via a communications system, the wireless device having a display, the method comprising:
(a) inputting a message into the remote wireless device;
(b) selecting at least one destination to where the message is to be sent from a plurality of destinations presented on the display;
(c) selecting at least one format in which the message is to be presented from a plurality of formats presented on the display;
(d) setting a time when the message to be sent to the selected destination;
(e) initiating a software timer in the wireless device;
(f) when the software timer expires, sending the message to the selected destination; and
(g) presenting the message in the selected format at a device associated with the selected destination.

37. The method of claim 36, wherein the communications system is a cable television system which includes a local device in communication with a remote server and a television, and the plurality of destinations include at least one of the local device, the television, a computer, the wireless device and another wireless device.

38. The method of claim 37, wherein the wireless devices are used to control the selection of program channels displayed on the television.

39. The method of claim 37, wherein the local device is one of a set-top box (STB) and a modem.

40. The method of claim 36, further comprising:
(h) encapsulating the message as a wireless message; and
(i) the device associated with the selected destination decoding the encapsulated message.

41. The method of claim 36, wherein the message is a reminder message.

42. The method of claim 36, wherein the format is at least one of text, audio and graphics.

43. The method of claim 36, wherein step (a) further comprises:
(a)(i) selecting a previously created message from a plurality of messages presented on the display.

44. A method of using a remote wireless device to send a message to at least one desired destination via a communications system, the wireless device having a display, the method comprising:
(a) inputting a message into the remote wireless device;
(b) selecting at least one destination to where the message is to be sent from a plurality of destinations presented on the display;
(c) selecting at least one format in which the message is to be presented from a plurality of formats presented on the display;
(d) sending the message to the selected destination; and
(e) presenting the message in the selected format at a device associated with the selected destination.

45. The method of claim 44, wherein the communications system is a cable television system which includes a local device in communication with a remote server and a television, and the plurality of destinations include at least one of the local device, the television, a computer, the wireless device and another wireless device.

46. The method of claim 45, wherein the wireless devices are used to control the selection of program channels displayed on the television.

47. The method of claim 45, wherein the local device is one of a set-top box (STB) and a modem.

48. The method of claim 44, further comprising:
(f) encapsulating the message as a wireless message; and
(g) the device associated with the selected destination decoding the encapsulated message.

49. The method of claim 44, wherein the message is an intercom message.

50. The method of claim 44, wherein the format is at least one of text, audio and graphics.

51. The method of claim 44, wherein step (a) further comprises:
(a)(i) selecting a previously created message from a plurality of messages presented on the display.
